(19) United States
(12) Patent Application Publication
(10) Pub. No.: US 2026/0353004 A1
(43) Pub. Date: Nov. 5, 2026

(54) ACOUSTIC STRUCTURE AND DRIVING METHOD OF DIRECT-DRIVE SIX-SPEAKER HEADPHONE

(71) Applicant: SHENZHEN SEVENSTAR TECHNOLOGY CO., LTD., Shenzhen City (CN)

(72) Inventors: WEI HUANG, Shenzhen City (CN); QIAN LI, Shenzhen City (CN)

(73) Assignee: SHENZHEN SEVENSTAR TECHNOLOGY CO., LTD., Shenzhen City (CN)

(21) Appl. No.: 19/722,824

(22) Filed: Jun. 27, 2026

Related U.S. Application Data
(63) Continuation of application No. PCT/CN2024/133094, filed on Nov. 20, 2024.

(30) Foreign Application Priority Data
Dec. 27, 2023 (CN) 202311834092.9

(51) Int. Cl. H04R 5/02; H04S 3/00

(52) U.S. Cl. CPC H04R 5/02; H04S 3/004; H04R 2205/022; H04R 2205/024; H04R 2420/09; H04S 2400/03; H04S 2400/13

(57) ABSTRACT

The present application provides an acoustic structure and a driving method of a direct-drive six-speaker headphone comprising: a main speaker, configured to play a main audio signal, the main audio signal being formed by combining a subwoofer-channel signal, a center-front-channel signal, and a single front-channel signal; a first auxiliary speaker, configured to play a single side-channel signal; and a second auxiliary speaker, configured to play a single rear-channel signal. A center of the main speaker is offset from a plate center of the speaker plate, and a distance between the first auxiliary speaker and the main speaker is smaller than a distance between the second auxiliary speaker and the main speaker. The present application solves the problem in the prior art that the audio playback effect is poor when two-channel sound output is employed for playback.

### CROSS-REFERENCE TO RELATED APPLICATION

The present application is a continuation of International Patent Application No. PCT/CN2024/133094 filed on Nov. 20, 2024, which claims the priority of Chinese Patent Application No. 202311834092.9, filed on Dec. 27, 2023, the entire contents of which are incorporated herein by reference.

### TECHNICAL FIELD

The present application relates to the technical field of audio playback devices, and more particularly, to an acoustic structure of a direct-drive six-speaker headphone and a driving method thereof.

### BACKGROUND

Audio formats include 2-channel, 2.1-channel, 3.1-channel, 5.1-channel, 7.1-channel, and the like, which are widely used for transmission and listening enjoyment in the fields of music, movies, games, and the like. Existing earphones typically adopt a left-and-right two-speaker design or a multi-speaker design utilizing traditional crossover-based frequency division, operating in a in a two-channel stereo mode. Multi-channel audio is virtually mixed into a two-channel sound output, resulting in loss, confusion, and distortion during reproduction of the multi-channel audio signals, causing illusions and confusion for the listener and preventing faithful sound reproduction. Therefore, when playback is performed using the existing two-channel sound output, the audio reproduction effect is poor.

Therefore, there remains room for improvement and development in the prior art.

### SUMMARY

In view of the above-described deficiencies of the prior art, an object of the present application is to provide an acoustic structure and a driving method of a direct-drive six-speaker headphone, which solve the problem of poor audio reproduction effects caused by the use of two-channel sound output for playback in the prior art.

In one aspect, the present application provides an acoustic structure of a direct-drive six-speaker headphone, comprising two speaker plates symmetrically arranged on left and right sides respectively, each of the speaker plates on both sides being provided with:
a main speaker, configured to play a main audio signal, the main audio signal being formed by combining a subwoofer-channel signal, a center-front-channel signal, and a single front-channel signal;
a first auxiliary speaker, configured to play a single side-channel signal; and
a second auxiliary speaker, configured to play a single rear-channel signal;
wherein a center of the main speaker is offset from a plate center of the speaker plate, a distance between the first auxiliary speaker and the main speaker is smaller than a distance between the second auxiliary speaker and the main speaker;
a center of the main speaker is located at a lower front position relative to the plate center, a center of the first auxiliary speaker is located at an upper front position relative to the plate center, a center of the second auxiliary speaker is located at an upper rear position relative to the plate center, and a distance from the center of the main speaker to the plate center is smaller than a distance from the center of the first auxiliary speaker to the plate center, and the distance from the center of the main speaker to the plate center is smaller than a distance from the center of the second auxiliary speaker to the plate center;
the first auxiliary speaker and the second auxiliary speaker both are disposed in sealed cavities on the speaker plate, outer sides of the first auxiliary speaker and the second auxiliary speaker are respectively provided with sealing covers, the sealing covers are located at a rear side of the speaker plate and enclose the sealed cavities, such that the speakers are disposed inside the sealing covers and the speakers are sealed and isolated from each other.

Optionally, a surface of the speaker plate facing away from a sound emitting side is configured as an arcuate surface, the arcuate surface having an arcuate low point; speaker planes of the main speaker, the first auxiliary speaker, and the second auxiliary speaker all being inclined toward the arcuate low point.

Optionally, inclination angles of the main speaker, the first auxiliary speaker, and the second auxiliary speaker are all equal.

Optionally, in a left-right direction, a distance from a center of the main speaker to the arcuate low point, a distance from a center of the first auxiliary speaker to the arcuate low point, and a distance from a center of the second auxiliary speaker to the arcuate low point are all equal.

Optionally, the speaker plate has a vertical use center line, and the first auxiliary speaker and the second auxiliary speaker are respectively disposed on two sides of the vertical use center line.

Optionally, the main speaker has a sound pressure level of 110 dB±10 dB, a frequency response of 20 Hz-20 kHz±10 dB, and a lowest resonant frequency of 80 Hz; the first auxiliary speaker and the second auxiliary speaker have identical specifications, and the first auxiliary speaker has a sound pressure level of 110 dB±10 dB, a frequency response of 20 Hz-20 kHz±10 dB, and a lowest resonant frequency of 240 Hz.

Optionally, a surface of the speaker plate 100 facing user's ear is defined as a sound-emitting vertical plane, and an orthographic projection contour of the speaker plate on the sound-emitting vertical plane adopts a circular, elliptical, or obround shape.

Optionally, the orthographic projection of the speaker plate is circular, with a diameter of 90 mm, the main speaker employs a speaker with a diameter of Ø 40 mm or Ø 50 mm, and the first auxiliary speaker and the second auxiliary speaker employ speakers with a diameter of Ø 20 mm or Ø 30 mm.

Optionally, a straight line vertically passing through the plate center is defined as a vertical use center line, a straight line horizontally passing through the plate center is defined as a horizontal use center line;
a distance from a center of the main speaker to the vertical use center line is 6.2 mm with an offset within ±30%; a distance from the center of the main speaker to the horizontal use center line is 16.2 mm with an offset within ±30%; and/or
a distance from a center of the first auxiliary speaker to the vertical use center line is 25.9 mm with an offset within ±30%, and a distance from the center of the first auxiliary speaker to the horizontal use center line is 22.4 mm with an offset within ±30%; and/or a distance from a center of the second auxiliary speaker to the vertical use center line is 17.1 mm with an offset within ±30%, and a distance from the center of the second auxiliary speaker to the horizontal use center line is 27.6 mm with an offset within ±30%.

In another aspect, the present application further provides a driving method of a direct-drive six-speaker head-mounted headphone, for the above acoustic structure of a direct-drive six-speaker headphone, the driving method comprising the steps of:
receiving a multi-channel audio signal and separating individual audio channel signals therefrom, wherein the individual audio channels at least comprise: a subwoofer-channel signal, a center-front-channel signal, a single front-channel signal, a single side-channel signal, and a single rear-channel signal;
individually performing characteristic processing on each of the individual audio channel signals, and combining the processed subwoofer-channel signal, center-front-channel signal, and single front-channel signal into a main channel signal; and
outputting the main channel signal to a main speaker on a corresponding side, outputting the processed single side-channel signal to a first auxiliary speaker on the corresponding side, and outputting the processed rear-channel signal to a second auxiliary speaker on the corresponding side.

Optionally, the step of individually performing characteristic processing on each of the audio channel signals specifically comprises:
supplementing frequency points of the channel signal through a spectral sub-algorithm according to a frequency response characteristic of the speaker, to obtain a high-fidelity restored signal;
adjusting phase parameters of the high-fidelity restored signal through a phase sub-algorithm according to position and inclination angle characteristics of the speaker, to eliminate power cancellation and frequency mixing caused by sound phase misalignment;
performing an emission angle adjustment on the phase-adjusted high-fidelity restored signal through an angle sub-algorithm, so that sound energy is focused on an ear;
adjusting time characteristics of the emission-angle-adjusted high-fidelity restored signal through a delay sub-algorithm based on time differences caused by positional angles and signal processing, so that multi-channel sounds entering the ear are synchronized; and
adjusting a volume of the time-characteristic-adjusted high-fidelity restored signal through a gain sub-algorithm, to match sensitivity of the corresponding speaker.

Optionally, the step of receiving the multi-channel audio signal and separating the individual audio channel signals therefrom, a multi-channel audio signal is directly obtained from an external audio output interface via a USB interface.

In another aspect, the present application further provides a driving method of a direct-drive six-speaker head-mounted headphone, comprising the steps of:
receiving a multi-channel audio signal and separating individual audio channel signals therefrom, wherein the individual audio channels at least comprise: a subwoofer-channel signal, a center-front-channel signal, a single front-channel signal, a single side-channel signal, and a single rear-channel signal;
individually performing characteristic processing on each of the individual audio channel signals, and combining the processed subwoofer-channel signal, center-front-channel signal, and single front-channel signal into a main channel signal; and
outputting the main channel signal to a main speaker on a corresponding side of the headphone, outputting the processed single side-channel signal to a first auxiliary speaker on the corresponding side, and outputting the processed rear-channel signal to a second auxiliary speaker on the corresponding side.

Optionally, the step of individually performing characteristic processing on each of the individual audio channel signals specifically comprises:
supplementing frequency points of the channel signal through a spectral sub-algorithm according to a frequency response characteristic of the speaker, to obtain a high-fidelity restored signal;
adjusting phase parameters of the high-fidelity restored signal through a phase sub-algorithm according to position and inclination angle characteristics of the speaker, to eliminate power cancellation and frequency mixing caused by sound phase misalignment;
performing an emission angle adjustment on the phase-adjusted high-fidelity restored signal through an angle sub-algorithm;
adjusting time characteristics of the emission-angle-adjusted high-fidelity restored signal through a delay sub-algorithm based on time differences caused by positional angles and signal processing; and
adjusting a volume of the time-characteristic-adjusted high-fidelity restored signal through a gain sub-algorithm, to match sensitivity of the corresponding speaker.

Optionally, the step of individually performing characteristic processing on each of the individual audio channel signals further comprises:
combining the subwoofer-channel signal, the center-front-channel signal, and the single front-channel signal after being subjected to the characteristic processing into a main channel signal.

Optionally, the step of receiving the multi-channel audio signal and separating the individual audio channel signals therefrom, a multi-channel audio signal is directly obtained from an external audio output interface via a direct-drive connector.

Optionally, the direct-drive connector is a USB interface, a fiber optic, or an HDMI interface.

Beneficial effects: In the acoustic structure and the driving method of the direct-drive six-speaker headphone and according to the present application, after directly obtaining a multi-channel audio signal, the subwoofer-channel signal, center-front-channel signal, and single front-channel signal are combined into one channel for output, so that an eight-channel audio signal is output through six speakers on left side and right sides respectively, thereby achieving authentic reproduction of multi-channel audio. Through the six speakers, each channel of the multi-channel audio can be clearly reproduced, with sound being delivered to each correct speaker unit, achieving high sound separation, clear playback, distortion-free reproduction, and accurate positioning. The original clarity, layering, spatial sense, positioning, and other panoramic elements of the sound are presented in a true and complete manner, ensuring that the user has a realistic, comfortable, and transparent experience. Furthermore, while realizing a realistic sound experience. Moreover, while achieving authentic sound perception, two front-center-channel speakers and two subwoofer-channel speakers are eliminated through channel combining, removing a total of four redundant speakers from both left and right sides, thereby reducing weight and cost, providing a lightweight wearing sensation for the user, alleviating fatigue, and enabling prolonged listening in an easy and natural manner.

### BRIEF DESCRIPTION OF THE DRAWINGS

FIG. 1 is a schematic structural diagram of a main portion of an acoustic structure of a direct-drive six-speaker headphone according to an embodiment of the present application;

FIG. 2 is an orthographic projection view of the main portion of the acoustic structure of a direct-drive six-speaker headphone according to an embodiment of the present application on a sound-emitting vertical plane;

FIG. 3 is an orthographic projection view of the main portion of the acoustic structure of a direct-drive six-speaker headphone according to an embodiment of the present application on a sound-emitting vertical plane with an arcuate surface schematic;

FIG. 4 is a schematic diagram of the principle of the main portion of the acoustic structure of a direct-drive six-speaker headphone according to an embodiment of the present application;

FIG. 5 is a flow block diagram of main steps of a driving method of a direct-drive six-speaker head-mounted headphone according to an embodiment of the present application;

FIG. 6 is a schematic diagram of the implementation principle of the driving method of a direct-drive six-speaker head-mounted headphone according to an embodiment of the present application;

FIG. 7 is a flow block diagram of characteristic processing of a single side-channel signal and a single rear-channel signal in the driving method of a direct-drive six-speaker head-mounted headphone according to an embodiment of the present application;

FIG. 8 is a flow block diagram of characteristic processing and combining of a main channel signal in the driving method of a direct-drive six-speaker head-mounted headphone according to an embodiment of the present application;

FIG. 9 is a schematic diagram of the principle of audio signal output in the driving method of a direct-drive six-speaker head-mounted headphone according to an embodiment of the present application.

In the drawings: 100, speaker plate; 110, arcuate surface; 111, arcuate low point; 112, sound-emitting vertical plane; 120, plate center; 130, vertical use center line; 140, horizontal use center line; 150, tuning hole; 200, main speaker; 210, inclination angle; 300, first auxiliary speaker; 400, second auxiliary speaker; 500, direct-drive connector; 600, digital-to-analog converter; 610, headphone amplifier.

### DETAILED DESCRIPTION OF THE EMBODIMENTS

To make the objects, technical solutions, and advantages of the present application clearer and more explicit, the present application will be further described in detail below with reference to the accompanying drawings and embodiments. It should be understood that the specific embodiments described herein are merely for explaining the present application and are not intended to limit the present application.

When two-channel audio output is employed for playback in the prior art, not only does the problem of poor audio reproduction effect exist. If full-channel output is adopted, it is necessary to provide speakers corresponding to each channel respectively, thereby requiring ten speakers to be installed on the entire headset, which results in a large number of speakers on the headset, heavy weight, not only high cost, but also easy user fatigue during long-term wearing. In addition, existing multi-channel output devices typically employ signal input interfaces that only support two-channel output, requiring driver installation to support multi-channel audio input; obtaining multiple channel signals by means of drivers causes problems of large signal delay and poor user experience. In gaming scenarios where reliance on sound for predicting position and distance is required, misjudgment may occur due to large delay and virtual sound effects.

One embodiment is as follows.

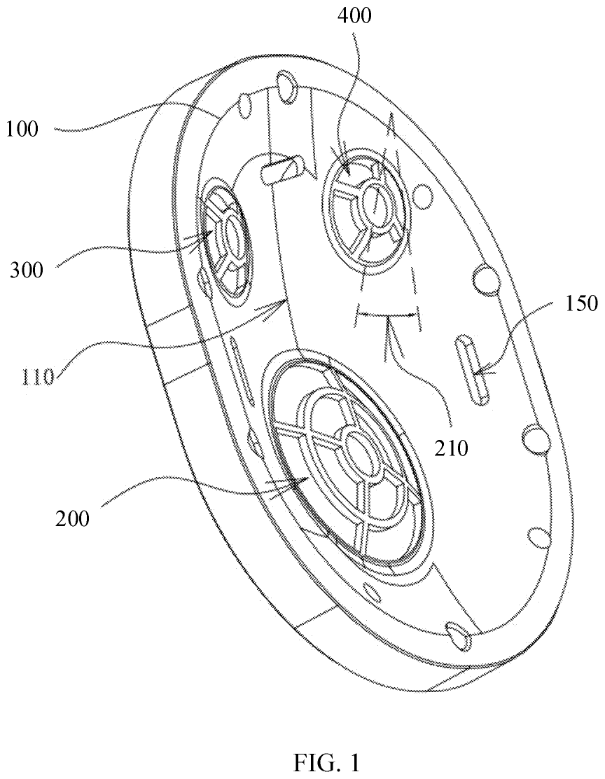

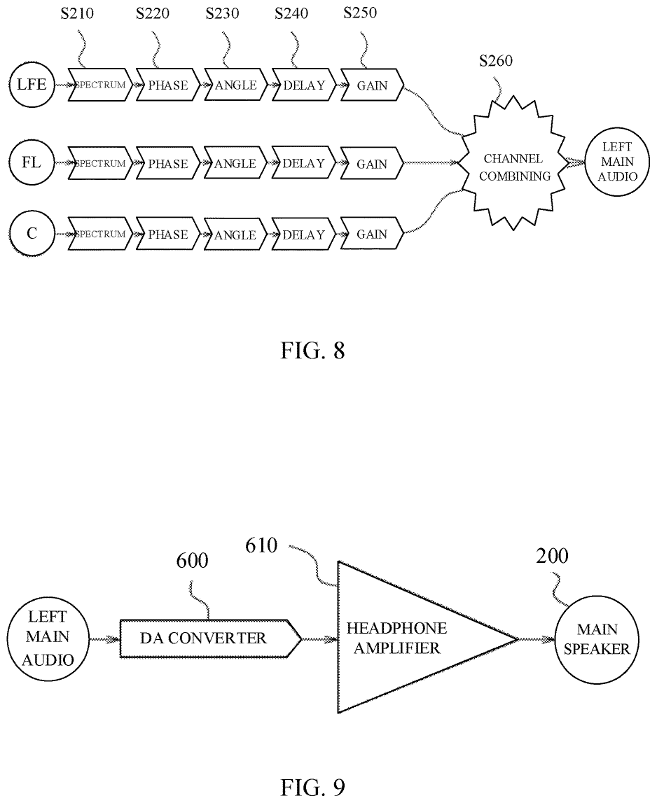

As shown in FIGS. 1, 6 and 8, the present embodiment proposes an acoustic structure of a direct-drive six-speaker headphone capable of playing multi-channel audio. Taking 7.1-channel format audio as a specific example for description, 7.1-channel format audio is divided into: a subwoofer-channel (LFE) signal, a center-front-channel (C) signal, a left-front-channel (FL) signal, a left-side-channel (SL) signal, a left-rear-channel (LR) signal, a right-front-channel (FR) signal, a right-side-channel (SR) signal, and a right-rear-channel (RR) signal, totaling eight channel signals. In an ideal state, ideal sound playback effects can be achieved by providing eight different speakers at corresponding directional positions relative to the user, with speakers at different positions playing corresponding channel signals. However, when applied to headphones, due to the small volume of headphones and short sound receiving distance, improvements are required. As shown in FIGS. 1, 2 and 4, the acoustic structure of a direct-drive six-speaker headphone in the present embodiment mainly comprises: two speaker plates 100 symmetrically arranged on left and right sides respectively. The left and right speaker plates 100 are used for fixing respective speakers. Since the left and right speaker plates 100 and the respective speakers thereon are all symmetrically arranged, the speaker plate 100 at one side is taken as an example for structural description. Furthermore, for multi-channel audio signals, the subwoofer-channel signal and the center-front-channel signal can be shared by left and right speakers. To distinguish between left-side-channel and right-side-channel, “single” is used to represent left side or right side. In the present embodiment, the left-side speaker of the headphone is used for description; unless otherwise specified, “single” refers to the left side. A side of the speaker facing the user's ear for sound emission is a sound-emitting side. A surface of the speaker plate 100 facing the user's ear is a sound-emitting vertical plane 112. The structural description herein is made with the sound-emitting vertical plane 112 in a vertical state.

As shown in FIGS. 1, 2 and 4, each of the left and right speaker plates 100 in the present embodiment is provided with: a main speaker 200, a first auxiliary speaker 300, and a second auxiliary speaker 400. In a specific structure, an orthographic projection contour of the speaker plate 100 on the sound-emitting vertical plane 112 may adopt a circular, elliptical, or obround shape. When the headphone is worn, the entire speaker plate 100 covers the user's ear. A center of the orthographic projection contour of the speaker plate 100 on the sound-emitting vertical plane 112 is taken as a plate center 120 of the present structure. During headphone use, the plate center 120 is aligned with the user's ear canal in an ideal wearing state. In the wearing state, a straight line vertically passing through the plate center 120 is defined as a vertical use center line 130, and a straight line horizontally passing through the plate center 120 is defined as a horizontal use center line 140, thereby forming a rectangular coordinate system (Cartesian coordinate system). The dimensional limitations of each speaker in the present embodiment are based on this coordinate system as a reference.

The main speaker 200 in the present embodiment is used for playing a main audio signal. The main audio signal is formed by combining a subwoofer-channel signal, a center-front-channel signal, and a single front-channel signal. The first auxiliary speaker 300 is used for playing a single side-channel signal. The second auxiliary speaker 400 is used for playing a single rear-channel signal. In a specific process, on the left side of the headphone, the subwoofer-channel signal, the center-front-channel signal, and the left-front-channel signal are combined to form the main audio signal. The main audio signal, the left-side-channel signal, and the left-rear-channel signal on this side are played respectively through the three speakers on the left side. On the right side of the headphone, the subwoofer-channel signal, the center-front-channel signal, and the right-front-channel signal are combined to form the main audio signal. The main audio signal, the right-side-channel signal, and the right-rear-channel signal on this side are played respectively through the three speakers on the right side. The subwoofer-channel signal and the center-front-channel signal respectively participate in the channel combining process on both left and right sides. Therefore, audio playback of eight channels in 7.1-channel format can be achieved through six speakers.

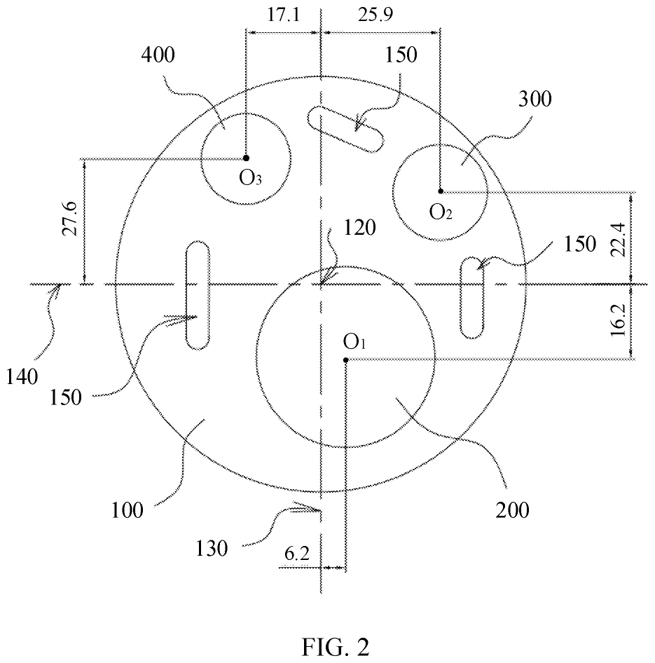

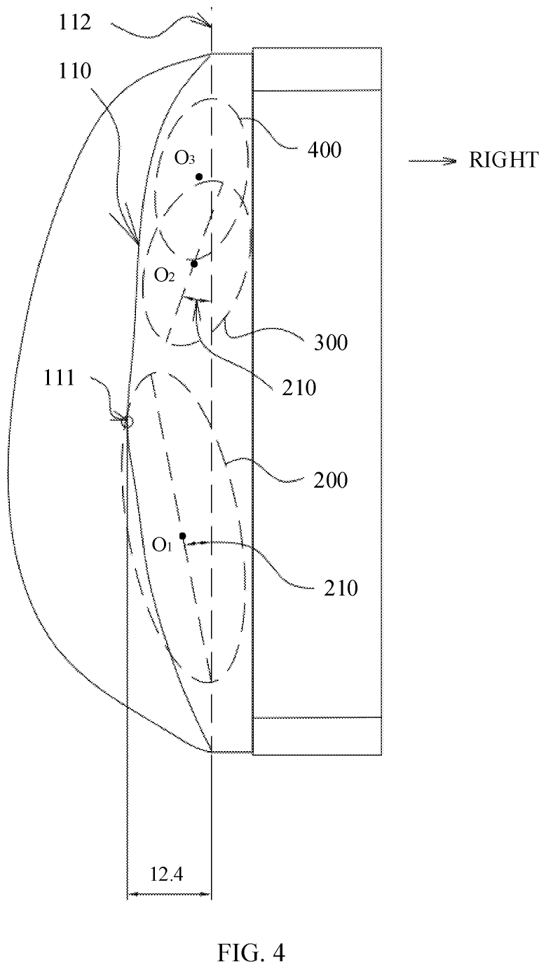

As shown in FIGS. 2 and 4, according to the present embodiment, in the orthographic projection of the speaker plate 100 on the sound-emitting vertical plane 112, a center O₁ of the main speaker 200 is offset from the plate center 120 of the speaker plate 100. The center of the main speaker 200 is located at a lower front position relative to the plate center 120. A center O₂ of the first auxiliary speaker 300 is located at an upper front position relative to the plate center 120. A center O₃ of the second auxiliary speaker 400 is located at an upper rear position relative to the plate center 120. Furthermore, a distance from the center O₁ of the main speaker 200 to the plate center 120 is smaller than the distance from the center O₂ of the first auxiliary speaker 300 to the plate center 120, and a distance from the center O₁ of the main speaker 200 to the plate center 120 is smaller than the distance from the center O₃ of the second auxiliary speaker 400 to the plate center 120. Thereby, the main speaker 200 is closer to the plate center 120, while the first auxiliary speaker 300 and the second auxiliary speaker 400 are farther from the plate center 120. Such arrangement causes the main audio signal to have a shorter playback path toward the user's ear and clearer playback sound. The single side-channel signal played by the first auxiliary speaker 300 is close to the user's ear, restoring the sound effect input from the side and more authentically reproducing the real effect of the single side-channel signal. The single rear-channel signal of the second auxiliary speaker 400 is input from behind the user's ear, thereby restoring the sound effect input from the rear and more authentically reproducing the real effect of the single rear-channel signal. A distance between the first auxiliary speaker 300 and the plate center 120 is smaller than a distance between the second auxiliary speaker 400 and the plate center 120; thereby, the propagation distance from the first auxiliary speaker 300 to the user's ear is shorter than that from the second auxiliary speaker 400, simulating the positional relationship of the first auxiliary speaker 300 being located at the side of the ear and simulating the positional relationship of the second auxiliary speaker 400 being located at the rear of the ear. The placement positions of the main speaker 200, the first auxiliary speaker 300, and the second auxiliary speaker 400 on the speaker plate 100 are matched with the respective directional positions of the channel signals, with the placement positions of the respective speakers in the head-mounted headphone embodying different channel directions, thereby achieving better playback effects.

As shown in FIGS. 1, 2 and 5, in the acoustic structure of a direct-drive six-speaker headphone of the present embodiment, after directly obtaining a multi-channel audio signal, for the output sound on one side, the subwoofer-channel signal, the center-front-channel signal, and the single front-channel signal on this side are combined into one channel for output. The single side-channel signal on this side is separately output as one channel. The single rear-channel signal on this side is separately output as one channel. For the output sound on the other side, the subwoofer-channel signal, the center-front-channel signal, and the single front-channel signal on the other side are combined into one channel for output. The single side-channel signal on the other side is separately output as one channel. The single rear-channel signal on the other side is separately output as one channel. Thereby, the eight-channel audio signal is output through six speakers on the left and right sides respectively, achieving authentic reproduction of multi-channel audio. Moreover, by employing the specially designed distribution positions of the main speaker 200, the first auxiliary speaker 300, and the second auxiliary speaker 400 on the speaker plate 100, the six speakers can clearly reproduce each channel of the multi-channel audio, delivering sound to each correct speaker, achieving effects of high sound separation, clear reproduction, no distortion, and accurate localization. The original clarity, layering, spatial sense, localization, and other panoramic elements of sound are authentically and completely presented, ensuring that users have authentic, comfortable, and transparent listening experiences. Moreover, while achieving authentic sound perception, two front-center speakers and two subwoofer speakers are eliminated through channel combining, removing a total of four redundant speakers from both left and right sides, thereby reducing weight and cost, making the user's wearing experience lighter, eliminating fatigue, and enabling long-term listening with natural authenticity.

As shown in FIGS. 1, 3 and 4, furthermore, in the present embodiment, a surface of the speaker plate 100 facing away from the sound-mitting side is configured as an arcuate surface 110, which is recessed outward in the left-right direction, thereby having an arcuate low point 111. The arcuate low point 111 is a point farthest from the sound-emitting vertical plane 112. The arcuate low point 111 is disposed as close as possible to the plate center 120, with a distance from the plate center 120 that may be 8.7 mm±2.5 mm. A speaker plane of the main speaker 200, a speaker plane of the first auxiliary speaker 300, and a speaker plane of the second auxiliary speaker 400 are all inclined toward the arcuate low point 111. A speaker plane of a speaker is a plane perpendicular to an axis of the speaker. By inclining the speaker planes of the respective speakers toward the arcuate low point 111, and by disposing the arcuate low point 111 as close as possible to the plate center 120, sound is concentrated toward the user's ear, reducing sound propagation paths and thereby reducing loss during sound propagation into the ear.

Inclination angles 210 of the main speaker 200, the first auxiliary speaker 300, and the second auxiliary speaker 400 relative to the sound-emitting vertical plane 112 in the present embodiment are all equal. By employing identical inclination angles 210, the sound propagation path characteristics of the respective speakers have uniformity. If unequal inclination angles 210 are employed, the inclination angles 210 alter the propagation paths, thereby requiring different scheme processing in software for different inclination angles 210 to improve sound quality, which increases the software processing steps and causes audio delay, thus affecting the sound presentation effect. By adopting identical inclination angles 210, the uniformity of signal processing for each loudspeaker is ensured, the processing steps are reduced, and the sound response speed is improved.

The inclination angle 210 in the present embodiment may be 12.3°. By employing this inclination angle 210, while ensuring uniformity of sound propagation paths of the respective speakers, the thickness of the entire speaker plate 100 can be reduced, decreasing the overall volume of the headphone.

In the present embodiment, in the left-right direction, the distances from the center O of the main speaker 200 to the arcuate low point 111, from the center O₂ of the first auxiliary speaker 300 to the arcuate low point 111, and from the center O₃ of the second auxiliary speaker 400 to the arcuate low point 111 are all equal. With the distances from the centers of the speakers to the arcuate low point 111 being equal, and with precise adjustment of the respective speaker data, frequency mixing interference and sound cancellation can be reduced when the speakers emit sound, the cleanness and intensity of the sound can be maintained, and the sound emitted from all speakers can be accurately converged into the human ear canal, allowing the human ear canal to obtain the most complete sound wave input and hear all the details of the sound. A distance (height difference) from the centers of the speakers to the arcuate low point 111 is 12.4 mm. While obtaining complete sound wave input, the sound waves of the respective speakers can be accurately converged into the human ear canal, achieving better sound effects.

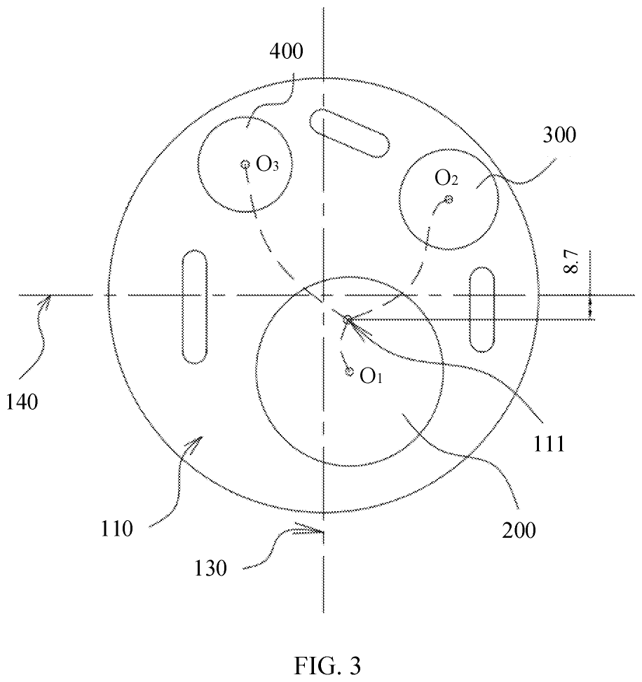

As shown in FIGS. 2 and 3, in the present embodiment, the first auxiliary speaker 300 and the second auxiliary speaker 400 are respectively disposed on two sides of the vertical use center line 130 of the speaker plate 100. The first auxiliary speaker is located at the front side of the vertical use center line, and the second auxiliary speaker 300 is located at a rear side of the vertical use center line 130. By employing this design, the sound emitted by the first auxiliary speaker 300 and the second auxiliary speaker 400 can be ensured to be distinguished, ensuring the accuracy of sound reproduction and avoiding erroneous sound emission. The sound of the first auxiliary speaker 300 and the second auxiliary speaker 400 also serve as important units for expressing sound layering, distance, and spatial sense. Maximizing the separation distance and horizontal offset allows the spatial sense of sound to be reproduced most completely.

In the present embodiment, the first auxiliary speaker 300 and the second auxiliary speaker 400 are both disposed in sealed cavities on the speaker plate 100. When the respective speakers are installed on the speaker plate 100, through holes are opened on the arcuate surface 110 of the speaker plate 100, causing the respective speakers to be located in the through holes and extend toward a rear side of the speaker plate 100, so that sound is emitted from a front side of the speaker plate 100 and emitted toward the through holes. In the present embodiment, the connection between the first auxiliary speaker 300 and the corresponding through hole is sealed, and the connection between the second auxiliary speaker 400 and the corresponding through hole is sealed. Sealing covers are respectively disposed on outer sides of the first auxiliary speaker 300 and the second auxiliary speaker 400. The sealing covers are located on the rear side of the speaker plate 100, and the sealing covers enclose the sealed cavities, thereby disposing the respective speakers inside the sealing covers and sealing and isolating the respective speakers from each other. Thereby, in the small cavity of the headphone, airflows generated by sound emission from the respective speakers do not interfere, avoiding interference between different sounds. However, in existing multi-speaker headphones, no sealing isolation is provided between speakers, which causes airflows generated by speaker vibration and sound emission to interfere with each other in the small cavity of the headphone, affecting speaker sound emission efficiency and causing mutual interference between different sounds. Therefore, by providing sealed cavities on the speaker plate 100, mutual interference of speaker vibration airflows is prevented, solving the problems of crosstalk, sound mixing, and reduced sound emission efficiency, further ensuring the sound quality of the headphone.

The speaker plate 100 of the present embodiment is further provided with tuning holes 150. Through the tuning holes 150, sound fine-tuning is performed at the factory, further ensuring the sound emission quality of the headphone. In the present embodiment, at least three tuning holes 150 are provided, with the respective tuning holes 150 respectively located between adjacent speakers.

As shown in FIGS. 2 and 3, in the specific structure of the present embodiment, the orthographic projection of the speaker plate 100 may be circular, with a diameter of 90 mm. The main speaker 200 may employ a speaker with a diameter of Ø 40 mm or Ø 50 mm. The first auxiliary speaker 300 and the second auxiliary speaker 400 have identical specifications, and may employ speakers with a diameter of Ø 20 mm or Ø 30 mm. The distance from the center O₁ of the main speaker 200 to the vertical use center line 130 is 6.2 mm, and the distance from the center O₁ of the main speaker 200 to the horizontal use center line 140 is 16.2 mm. The distance from the center O₂ of the first auxiliary speaker 300 to the vertical use center line 130 is 25.9 mm, and the distance from the center O₂ of the first auxiliary speaker 300 to the horizontal use center line 140 is 22.4 mm. The distance from the center O3 of the second auxiliary speaker 400 to the vertical use center line 130 is 17.1 mm, and the distance from the center O₂ of the second auxiliary speaker to the horizontal use center line 140 is 27.6 mm. The above dimensions allow an offset within ±30% to accommodate different personalized designs. Within the offset range, matching adjustments can be made using multi-channel combining algorithms to achieve optimal acoustic effects. The above data regarding speaker placement positions, speaker angles, and the arcuate surface 110 of the speaker plate 100 are designed based on ergonomics according to the size and shape of the headphone, ensuring that all sound emitted from the speakers is accurately converged into the human ear canal, allowing the human ear canal to obtain the most complete sound wave input and hear all details of the sound.

Furthermore, the main speaker 200 has a sound pressure level (SPL) of 110 dB±10 dB, a frequency response of 20 Hz-20 kHz±10 dB, and a lowest resonant frequency of 80 Hz, being a slightly low-frequency full-range speaker. The first auxiliary speaker 300 and the second auxiliary speaker 400 have identical specifications. Taking the first auxiliary speaker 300 as an example, its sound pressure level (SPL) is 110 dB±10 dB, its frequency response is 20 Hz-20 kHz±10 dB, and its lowest resonant frequency is 240 Hz, being a mid-high frequency loudspeaker biased toward high frequencies. By employing speakers with the above specifications, the characteristics of the respective channels are better matched, and the design shape of the arcuate surface 110 of the speaker plate 100 is coordinated, achieving flatter frequency response characteristics of the output sound.

Another embodiment is as follows.

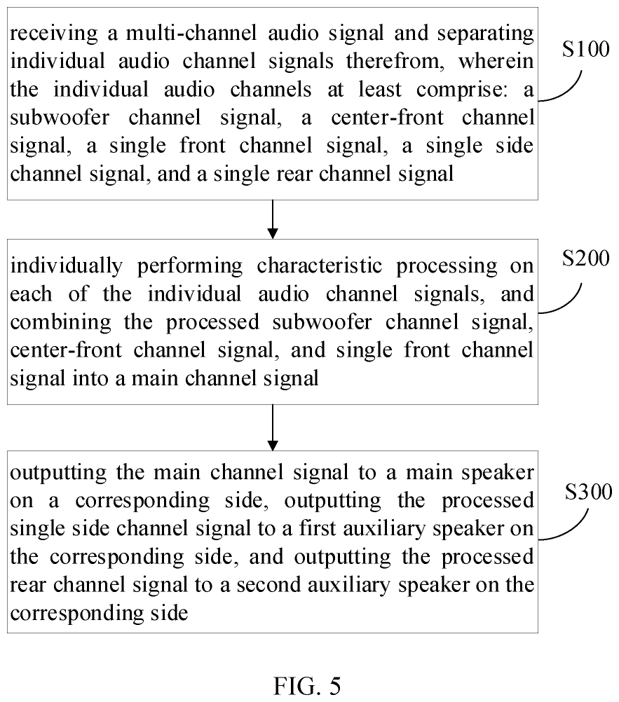

As shown in FIGS. 5 and 6, the present embodiment further proposes a driving method of a direct-drive six-speaker head-mounted headphone, comprising the steps of:

Step S100: Receiving multi-channel audio signal and separating individual audio channel signals therefrom, wherein the individual audio channels at least comprise: a subwoofer-channel signal, a center-front-channel signal, a single front-channel signal, a single side-channel signal, and a single rear-channel signal.

Herein, the single front-channel signals comprise two groups, namely a left-front-channel signal and a right-front-channel signal respectively. The single side-channel signals comprise two groups, namely a left-side-channel signal and a right-side-channel signal respectively. The single rear-channel signals comprise two groups, namely a left-rear-channel signal and a right-rear-channel signal respectively.

In existing multi-speaker headphones, a crossover divider is employed between speakers. A mixed audio input signal is indiscriminately intercepted to output to corresponding speakers, causing sounds that should not be present in certain speakers to also be delivered thereto, resulting in erroneous sound reproduction. Meanwhile, due to the relatively high impedance of the crossover divider, the overall impedance of the headphone is increased, resulting in reduced sensitivity of the entire speaker and loss of some sound details.

In the present headphone, a direct-drive connector 500 (e.g., a USB interface) is employed to directly obtain a multi-channel audio signal from an external audio output interface. Through the USB interface, the headphone is plugged into a computer, a mobile phone, a tablet, a television, or other device having a USB audio output interface, without the need to install a driver program, and multi-channel audio signals are directly received from these devices. The USB interface is in USB-A or USB-C (Type-C) mode, employing USB 1.0/2.0/3.0/3.1 data protocols and USB Audio UAC 1.0/2.0 specifications, receiving multi-channel audio and sending it to a digital audio processor for data processing. It should be noted that, in addition to the USB interface, the direct-drive connector 500 may also be a fiber optic, a coaxial interface, or an HDMI interface, all of which can obtain multi-channel data. By directly obtaining multi-channel audio signals, delay and distortion caused by driver programs are reduced, preserving sound details as much as possible.

In home theaters or speaker power amplifiers, each channel is equipped with an independent speaker, with a predetermined spacing maintained therebetween to prevent intermodulation distortion resulting from frequency mixing interference between sounds. In headphone applications, because the space of the headphone is very small, if a design with an independent speaker for each channel is adopted, the distance between each speaker is very close, and audio signals will produce frequency mixing, resulting in sound distortion or cancellation and affecting the listening experience. Meanwhile, with one speaker per channel, under the requirement of 7.1-channel, each side of the headphone would have five speakers, with ten speakers on both sides, causing problems such as increased headphone volume, increased weight, and distorted sound effects. Therefore, the following steps are employed for optimization processing.

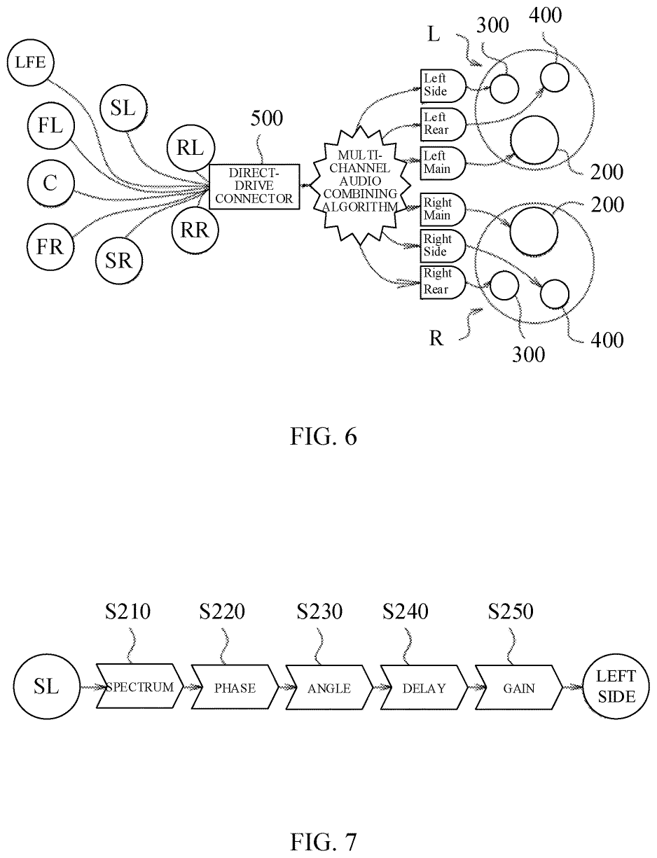

As shown in FIGS. 5, 6 and 7, Step S200: Individually performing characteristic processing on each of the individual audio channel signals, and combining the processed subwoofer-channel signal, center-front-channel signal, and single front-channel signal into a main channel signal.

The input audio channel signals are processed through a multi-channel audio combining algorithm. The multi-channel audio combining algorithm parses the multi-channel audio signal sent from the USB interface, separates the respective channel data, and combines the subwoofer-channel signal, the center-front-channel signal, and the single front-channel signal into one channel for output, so that the eight-channel audio signals are respectively output through six speakers on the left and right sides, thereby achieving authentic reproduction of multi-channel audio. Moreover, while achieving authentic sound perception, two front-center speakers and two subwoofer speakers are eliminated through channel combining, removing a total of four redundant speakers from both left and right sides, reducing weight and cost, making the user's wearing experience lighter, reducing fatigue, and enabling long-term listening with physical and mental pleasure.

In Step S200, the step of individually performing characteristic processing on each of the individual audio channel signals specifically comprises:

Step S210: Supplementing frequency points of the channel signal through a spectral sub-algorithm according to a frequency response characteristic of the speaker, to obtain a high-fidelity restored signal. Specifically: according to the characteristics of each channel and the specifications of the speaker, the frequency band that the speaker can reproduce without distortion is intercepted, and relevant frequency points are compensated according to the frequency response characteristics of the speaker, creating basic conditions for high-fidelity sound reproduction.

Step S220: Adjusting phase parameters of the high-fidelity restored signal through a phase sub-algorithm according to position and inclination angle characteristics of the speaker, to eliminate power cancellation and frequency mixing caused by sound phase misalignment. Specifically: according to the characteristics of the speaker cavity design, the phase of the sound is adjusted, correcting phase errors or misalignment, preventing energy cancellation or loss and affecting sound characteristics.

Step S230: Performing an emission angle adjustment on the phase-adjusted high-fidelity restored signal through an angle sub-algorithm, so that sound energy is focused on an ear. Specifically, adjustments are made for emission angle changes caused by the speaker placement in the acoustic structure design, ensuring that sound energy is focused on the ear, making ergonomic adjustment adaptations.

Step S240: Adjusting time characteristics of the emission-angle-adjusted high-fidelity restored signal through a delay sub-algorithm based on time differences caused by positional angles and signal processing, so that multi-channel sounds entering the ear are synchronized. Specifically, according to the characteristics of different channels, the time characteristics are adjusted in the entire sound playback architecture, creating the original spatial characteristics of multiple sounds.

Step S250: Adjusting a volume of the time-characteristic-adjusted high-fidelity restored signal through a gain sub-algorithm, to match sensitivity of the corresponding speaker. Specifically, the volume of each channel is adjusted to match the sensitivity of each speaker, achieving balanced volume of each speaker and uniform sound energy effects.

Among the eight channels, the left-side-channel, the right-side-channel, the left-rear-channel, and the right-rear-channel have similar characteristics, mainly used for expressing scene, layering, orientation, and distance of the sound field, with frequency characteristics biased toward the mid-high frequency range. The signals of these four channels are respectively subjected to the above-described characteristic processing in accordance with the characteristics, layout, and positional relationships of their corresponding speakers, and are then respectively directly output as a left-side-channel signal, a right-side-channel signal, a left-rear-channel signal, and a right-rear-channel signal. These signals can be respectively output through the first auxiliary speaker on the left side, the first auxiliary speaker on the right side, the second auxiliary speaker on the left side, and the second auxiliary speaker on the right side.

The subwoofer-channel, the center-front-channel, the left-front-channel, and the right-front-channel are the most important parts of the audio signals. The subwoofer-channel, the center-front-channel, the left-front-channel, and the right-front-channel are not mixed with the above four channels in any way. After the subwoofer-channel, the center-front-channel, the left-front, and the right-front-channel are respectively subjected to the above-described characteristic processing, the subwoofer-channel, the center-front-channel, and the left-front-channel need to be combined, and the subwoofer-channel, the center-front-channel, and the right-front-channel need to be combined. Taking one group as an example, as shown in FIGS. 5, 6 and 8, Step S200 further comprises:

Step S260: Combining the subwoofer-channel signal, the center-front-channel signal, and the single front-channel signal after being subjected to the characteristic processing into a main channel signal.

In the specific process, the subwoofer-channel represents the low-frequency portion of the audio, containing the maximum energy of the audio, with frequencies typically below 200 Hz. Erroneous delivery of the subwoofer will impact the speaker, causing sound distortion and aberration. Therefore, the processing of the subwoofer-channel requires particular care; after characteristic processing, it is sent to a combiner for combined output. The center-front-channel is the main vocal soul of the audio, being a full-range signal with a frequency response range from 5 Hz to 20 kHz. After characteristic processing, the flattest reproduction characteristics are achieved, and it is sent to the combiner as the main sound for combining and output. The single front-channel (the left-front-channel or the right-front-channel) is the auxiliary main sound of the multi-channel audio; the entire sound field characteristics of the sound are expressed in the single front-channel (the left-front-channel or the right-front-channel). After characteristic processing, the main sound field is restored and sent to the combiner for combined output. Through the above combining algorithm, by employing a high-sensitivity full-range speaker, and according to the characteristics of the subwoofer-channel, center-front-channel, and single front-channel, combined with the specification indexes and positional layout of the speaker, and the structure of the headphone speaker plate and cavity, the subwoofer-channel, center-front-channel, and left-front-channel are combined into a left-side main channel signal in a precise digital algorithm manner and output through the left-side main speaker. The subwoofer-channel, center-front-channel, and right-front-channel are combined into a right-side main channel signal and output through the right-side main speaker. Combined with the high-sensitivity wide-frequency-response main speaker, sound can be reproduced without distortion, efficiently and precisely solving problems of sound frequency mixing interference, sound distortion, headphone weight, headphone volume, etc., while also reducing the overall cost of the headphone, enabling multi-channel reproduction to be realized in the headphone field.

Step S300: Outputting the main channel signal to a corresponding main speaker, outputting the processed single side-channel signal to a corresponding first auxiliary speaker, and outputting the processed rear-channel signal to a corresponding second auxiliary speaker.

As shown in FIG. 9, in the specific process, a channel-independent direct-drive mode is employed, with a drive circuit outputting respective channel signals to corresponding speakers, thereby achieving the six-speaker direct-drive of the present headphone. The drive circuit is composed of a digital-to-analog (DA) converter 600 and a headphone amplifier 610, being an important mode of six-speaker direct-drive. The main channel signal processed by the multi-channel combining algorithm is converted to an analog signal by an independent digital-to-analog converter 600, amplified by the headphone amplifier 610, and becomes a low-impedance speaker drive signal, driving the main speaker 200 for single-sound playback. The sound output modes of the other respective speakers are the same as that of the main speaker 200. Therefore, in the headphone, the sound of each channel is precisely delivered to the correct speaker, ensuring the accuracy of sound reproduction and avoiding erroneous sound emission. Meanwhile, the main channel signal, the single side-channel signal, and the single rear-channel signal are respectively driven in independent drive modes, sound details are not lost, completely reproducing the complete sound, solving the problem of erroneous channel delivery.

It should be noted that the multi-channel design example in the present embodiment is specifically described based on eight channels in 7.1-channel, and the headphone of the present embodiment is equally applicable to the processing of 2-channel, 2.1-channel, 3.1-channel, and 5.1-channel audio. The number of channels in these channel formats is less than that in 7.1-channel. Therefore, in the processing of these channel formats, for channels that do not exist, there is no output signal and no signal output is performed, which does not affect the use of the present headphone.

In summary, the present application proposes an acoustic structure and a driving method of a direct-drive six-speaker headphone. By employing a signal direct transmission mode such as USB, multi-channel audio signals are directly obtained without a driver program, reducing delay and distortion caused by driver programs. By employing a driver-program-free data acquisition mode, audio signals are delivered to the ear with almost no delay. In competitive games where applications rely on sound for positioning, the best performance is achieved, improving the competitive ability of game players. After directly obtaining multi-channel audio signals, the subwoofer-channel signal, center-front-channel signal, and single front-channel signal are combined into one channel for output, thereby enabling the eight-channel audio signal to be output through six speakers on the left and right sides respectively, achieving authentic reproduction of multi-channel audio. Through the six speakers, each channel of the multi-channel audio can be clearly reproduced, with sound being delivered to each correct speaker unit, achieving effects of high sound separation, clear reproduction, no distortion, and accurate localization. The original clarity, layering, spatial sense, localization, and other panoramic elements of sound are authentically and completely presented, ensuring that users have authentic, comfortable, and transparent listening experiences. Moreover, while achieving authentic sound perception, two front-center speakers and two subwoofer speakers are eliminated through channel combining, removing a total of four redundant speakers from both left and right sides, thereby reducing weight and cost, making the user's wearing experience lighter, reducing fatigue, and enabling long-term listening with ease and naturalness. The layout of three speakers on each of the left and right sides and the arcuate surface design of the speaker plate enable multi-channel audio to be correctly reproduced and accurately input into the ear canal. For the first auxiliary speaker and the second auxiliary speaker, independent sealed cavities are employed to prevent crosstalk between channels and ensure the accuracy of channel reproduction.

The above embodiments are merely for illustrating the technical solutions of the present application, and are not intended to limit the present application. Although the present application has been described in detail with reference to the foregoing embodiments, those of ordinary skill in the art should understand that they may still make modifications to the technical solutions described in the foregoing embodiments, or make equivalent replacements to some technical features thereof. These modifications or replacements do not cause the essence of the corresponding technical solutions to depart from the spirit and scope of the technical solutions of the embodiments of the present application.

What is claimed is:

1. An acoustic structure of a direct-drive six-speaker headphone, comprising: two speaker plates symmetrically arranged on left and right sides respectively, each of the speaker plates on both sides being provided with:
a main speaker, configured to play a main audio signal, the main audio signal being formed by combining a subwoofer-channel signal, a center-front-channel signal, and a single front-channel signal;
a first auxiliary speaker, configured to play a single side-channel signal; and
a second auxiliary speaker, configured to play a single rear-channel signal;
wherein a center of the main speaker is offset from a plate center of the speaker plate, a distance between the first auxiliary speaker and the main speaker is smaller than a distance between the second auxiliary speaker and the main speaker;
a center of the main speaker is located at a lower front position relative to the plate center, a center of the first auxiliary speaker is located at an upper front position relative to the plate center, a center of the second auxiliary speaker is located at an upper rear position relative to the plate center, and a distance from the center of the main speaker to the plate center is smaller than a distance from the center of the first auxiliary speaker to the plate center, and the distance from the center of the main speaker to the plate center is smaller than a distance from the center of the second auxiliary speaker to the plate center;
the first auxiliary speaker and the second auxiliary speaker both are disposed in sealed cavities on the speaker plate, outer sides of the first auxiliary speaker and the second auxiliary speaker are respectively provided with sealing covers, the sealing covers are located at a rear side of the speaker plate and enclose the sealed cavities, such that the speakers are disposed inside the sealing covers and the speakers are sealed and isolated from each other.

2. The acoustic structure of a direct-drive six-speaker headphone according to claim 1, wherein a surface of the speaker plate facing away from a sound emitting side is configured as an arcuate surface, the arcuate surface having an arcuate low point; speaker planes of the main speaker, the first auxiliary speaker, and the second auxiliary speaker all being inclined toward the arcuate low point.

3. The acoustic structure of a direct-drive six-speaker headphone according to claim 2, wherein inclination angles of the main speaker, the first auxiliary speaker, and the second auxiliary speaker are all equal.

4. The acoustic structure of a direct-drive six-speaker headphone according to claim 2, wherein in a left-right direction, a distance from a center of the main speaker to the arcuate low point, a distance from a center of the first auxiliary speaker to the arcuate low point, and a distance from a center of the second auxiliary speaker to the arcuate low point are all equal.

5. The acoustic structure of a direct-drive six-speaker headphone according to claim 1, wherein the speaker plate has a vertical use center line, and the first auxiliary speaker and the second auxiliary speaker are respectively disposed on two sides of the vertical use center line.

6. The acoustic structure of a direct-drive six-speaker headphone according to claim 2, wherein the main speaker has a sound pressure level of 110 dB±10 dB, a frequency response of 20 Hz-20 kHz±10 dB, and a lowest resonant frequency of 80 Hz;
the first auxiliary speaker and the second auxiliary speaker have identical specifications, and the first auxiliary speaker has a sound pressure level of 110 dB±10 dB, a frequency response of 20 Hz-20 kHz±10 dB, and a lowest resonant frequency of 240 Hz.

7. The acoustic structure of a direct-drive six-speaker headphone according to claim 1, wherein a surface of the speaker plate 100 facing user's ear is defined as a sound-emitting vertical plane, and an orthographic projection contour of the speaker plate on the sound-emitting vertical plane adopts a circular, elliptical, or obround shape.

8. The acoustic structure of a direct-drive six-speaker headphone according to claim 7, wherein the orthographic projection of the speaker plate is circular, with a diameter of 90 mm, the main speaker employs a speaker with a diameter of Ø 40 mm or Ø 50 mm, and the first auxiliary speaker and the second auxiliary speaker employ speakers with a diameter of Ø 20 mm or Ø 30 mm.

9. The acoustic structure of a direct-drive six-speaker headphone according to claim 8, wherein a straight line vertically passing through the plate center is defined as a vertical use center line, a straight line horizontally passing through the plate center is defined as a horizontal use center line;
a distance from a center of the main speaker to the vertical use center line is 6.2 mm with an offset within ±30%; a distance from the center of the main speaker to the horizontal use center line is 16.2 mm with an offset within ±30%; and/or a distance from a center of the first auxiliary speaker to the vertical use center line is 25.9 mm with an offset within ±30%, and a distance from the center of the first auxiliary speaker to the horizontal use center line is 22.4 mm with an offset within ±30%; and/or a distance from a center of the second auxiliary speaker to the vertical use center line is 17.1 mm with an offset within ±30%, and a distance from the center of the second auxiliary speaker to the horizontal use center line is 27.6 mm with an offset within ±30%.

10. A driving method of a direct-drive six-speaker head-mounted headphone, for the acoustic structure of a direct-drive six-speaker headphone according to claim 1, the driving method comprising the steps of:
receiving a multi-channel audio signal and separating individual audio channel signals therefrom, wherein the individual audio channels at least comprise: a subwoofer-channel signal, a center-front-channel signal, a single front-channel signal, a single side-channel signal, and a single rear-channel signal;
individually performing characteristic processing on each of the individual audio channel signals, and combining the processed subwoofer-channel signal, center-front-channel signal, and single front-channel signal into a main channel signal; and
outputting the main channel signal to a main speaker on a corresponding side, outputting the processed single side-channel signal to a first auxiliary speaker on the corresponding side, and outputting the processed rear-channel signal to a second auxiliary speaker on the corresponding side.

11. The driving method according to claim 10, wherein the step of individually performing characteristic processing on each of the audio channel signals specifically comprises:
supplementing frequency points of the channel signal through a spectral sub-algorithm according to a frequency response characteristic of the speaker, to obtain a high-fidelity restored signal;
adjusting phase parameters of the high-fidelity restored signal through a phase sub-algorithm according to position and inclination angle characteristics of the speaker, to eliminate power cancellation and frequency mixing caused by sound phase misalignment;
performing an emission angle adjustment on the phase-adjusted high-fidelity restored signal through an angle sub-algorithm, so that sound energy is focused on an ear;
adjusting time characteristics of the emission-angle-adjusted high-fidelity restored signal through a delay sub-algorithm based on time differences caused by positional angles and signal processing, so that multi-channel sounds entering the ear are synchronized; and
adjusting a volume of the time-characteristic-adjusted high-fidelity restored signal through a gain sub-algorithm, to match sensitivity of the corresponding speaker.

12. The driving method according to claim 10, wherein the step of receiving the multi-channel audio signal and separating the individual audio channel signals therefrom, a multi-channel audio signal is directly obtained from an external audio output interface via a USB interface.

13. A driving method of a direct-drive six-speaker head-mounted headphone, comprising the steps of:
receiving a multi-channel audio signal and separating individual audio channel signals therefrom, wherein the individual audio channels at least comprise: a subwoofer-channel signal, a center-front-channel signal, a single front-channel signal, a single side-channel signal, and a single rear-channel signal;
individually performing characteristic processing on each of the individual audio channel signals, and combining the processed subwoofer-channel signal, center-front-channel signal, and single front-channel signal into a main channel signal; and
outputting the main channel signal to a main speaker on a corresponding side of the headphone, outputting the processed single side-channel signal to a first auxiliary speaker on the corresponding side, and outputting the processed rear-channel signal to a second auxiliary speaker on the corresponding side.

14. The driving method according to claim 13, wherein the step of individually performing characteristic processing on each of the individual audio channel signals specifically comprises:
supplementing frequency points of the channel signal through a spectral sub-algorithm according to a frequency response characteristic of the speaker, to obtain a high-fidelity restored signal;
adjusting phase parameters of the high-fidelity restored signal through a phase sub-algorithm according to position and inclination angle characteristics of the speaker, to eliminate power cancellation and frequency mixing caused by sound phase misalignment;
performing an emission angle adjustment on the phase-adjusted high-fidelity restored signal through an angle sub-algorithm;
adjusting time characteristics of the emission-angle-adjusted high-fidelity restored signal through a delay sub-algorithm based on time differences caused by positional angles and signal processing; and
adjusting a volume of the time-characteristic-adjusted high-fidelity restored signal through a gain sub-algorithm, to match sensitivity of the corresponding speaker.

15. The driving method according to claim 14, wherein the step of individually performing characteristic processing on each of the individual audio channel signals further comprises:
combining the subwoofer-channel signal, the center-front-channel signal, and the single front-channel signal after being subjected to the characteristic processing into a main channel signal.

16. The driving method according to claim 13, wherein the step of receiving the multi-channel audio signal and separating the individual audio channel signals therefrom, a multi-channel audio signal is directly obtained from an external audio output interface via a direct-drive connector.

17. The driving method according to claim 16, wherein the direct-drive connector is a USB interface, a fiber optic, or an HDMI interface.
